(19) United States
(12) Patent Application Publication
(10) Pub. No.: US 2022/0293986 A1
(43) Pub. Date: Sep. 15, 2022

(54) MEMBRANE-ELECTRODE ASSEMBLY (MEA) AND METHODS OF PRODUCING THE SAME

(71) Applicant: BRETON S.P.A., Castetlo di Godego (TV) (IT)

(72) Inventors: Vito Di Noto, Cadoneghe (PD) (IT); Enrico Negro, Camposanpiero (PD) (IT); Angeloclaudio Nale, Padova (PD) (IT); Yannick Herve Bang, Padova (PD) (IT); Keti Vezzu', Rovolon (PD) (IT); Gioele Pagot, Santa Lucia di Piave (TV) (IT)

(21) Appl. No.: 17/635,050

(22) PCT Filed: Oct. 7, 2020
(86) PCT No.: PCT/IB2020/059401

§ 371 Date: Feb. 14, 2022

(30) Foreign Application Priority Data
Oct. 8, 2019 (IT) 102019000018182

(51) Int. Cl. H01M 8/1004; H01M 4/90; H01M 4/88; H01M 4/86; H01M 8/1081

(52) U.S. Cl. CPC H01M 8/1004; H01M 4/9016; H01M 4/8825; H01M 4/8657; H01M 8/1081; H01M 2008/1095

(57) ABSTRACT

The present invention refers to new membrane-electrode assembly (MBA), methods of producing the same as well as fuel cell comprising said MBA.

### FIELD OF THE INVENTION

The present invention refers to new membrane-electrode assemblies (MEAs), methods of producing the same as well as fuel cell comprising said MEAs. The aforementioned assemblies exhibit improved performances, by reducing losses associated with charge and mass transport phenomena.

The heart of modern polymer membrane fuel cells (FCs) is the so-called membrane-electrode assembly (MEA). The MEA is a two-dimensional multilayer system comprising all the fundamental components necessary to make the FC work. These comprise:

1. An ion-exchange membrane, apt to conduct the ionic species involved in the operation of the particular FC. Different types of FC require membranes apt to conduct different ionic species. For example, a “Proton-Exchange Membrane Fuel Cell”, PEMFC, comprises a membrane capable of conducting H₃O⁺ ions. A “Anion-Exchange Membrane Fuel Cell”, AEMFC, comprises instead a membrane capable of conducting OH⁻ ions.

2. The ion-exchange membrane is coated on both sides by an “electrocatalytic layer”.

3. Each electrocatalytic layer is, in turn, coated by a “gas diffusion electrode”; these two electrocatalytic layers ensure the following functions: (i) they serve to make the reagents necessary for the FC operation reach the electrocatalytic layers; (ii) they are used to remove the products developed as a result of the electrochemical processes necessary for the FC operation from the MEA; and (iii) they place the electrocatalytic layers in electrical contact with the external circuit. The electrocatalytic layers are the place where the oxidation or reduction processes necessary for the operation of the entire FC take place. Within the electrocatalytic layer are located the “active sites” that:

1. Are in ionic contact with the electrolytic membrane of the FC. For example, in a PEMFC: (i) at the anode, these sites expel H₃O⁺ ions towards the membrane; while (ii) at the cathode, these sites receive H₃O⁺ ions from the membrane.

2. Are exposed to the reagents used to feed the FC. For example, in a PEMFC: (i) at the anode, these sites are exposed to hydrogen; while (ii) at the cathode, they are exposed to oxygen.

3. Are in electrical contact with the external circuit. For example, in a PEMFC: (i) at the anode, these sites convey electrons out of the system into the external circuit; while (ii) at the cathode, these sites absorb electrons coming from the external circuit. In order for the “active sites” comprised in the electrocatalytic layer to be in ionic contact with the electrolytic membrane of the FC, it is necessary to create suitable percolation paths apt to transport the ions of interest. The latter ions are involved, as reactants or products, in the electrochemical processes taking place at the FC electrodes; if these ions cannot reach, or are not removed from, the “active sites”, the electrochemical processes necessary to operate the entire FC cannot take place and the device does not produce current.

To create the percolation paths apt to transport the ions of interest, a certain amount of an ion-exchange polymer, capable of easily conducting the same ions that migrate through the electrolytic membrane, is introduced into the electrocatalytic layer. The optimal amount of such polymer depends on various factors, including the electrocatalyst morphology. On the one hand, if the electrocatalytic layer does not comprise enough ion-exchange polymer, many of the “active sites” contained in the same electrocatalytic layer cannot be reached by the ionic species and are therefore unable to function. On the other hand, if the amount of ion-exchange polymer is excessive, the latter: (i) covers the “active sites”, blocking their operation; and (ii) electrically isolates the different grains into which the electrocatalyst is divided, blocking the transport of electrons between the “active sites” and the external circuit. In order for the ions of interest to easily migrate between the electrocatalytic layer and the electrolytic membrane, or vice versa, it is essential that the interface between these two components is smooth and homogeneous. In this way, no bubbles or other discontinuities capable of blocking the migration of ions between the electrolytic membrane and the ion-exchange polymer comprised in the electrocatalytic layer will be introduced as a result of the various processes involved in the MEA production. In order for each electrocatalytic layer to work optimally, it has to maximize the speed at which the specific redox process occurs at the electrode. For example, in a PEMFC: (i) at the anode, this process is the hydrogen electro-oxidation reaction; and (ii) at the cathode, this process is the oxygen reduction reaction. The “active sites” within each electrocatalytic layer are provided by a suitable electrocatalyst material. The chemical composition and structure of these “active sites” are suitably modulated in order to accelerate the redox process of interest. For example, in a PEMFC, the “active sites” are typically based on platinum, present in the form of nanoparticles with a diameter typically comprised between 2 and 5 nm.

However, although the intrinsic speed at which a certain redox process occurs is fundamental, the optimal operation of an electrocatalytic layer also requires that the “active sites”:

1. are able to receive all the reagents necessary to carry out the redox process of interest;

2. are able to expel all the products of the redox process of interest;

3. are in good electrical contact with the external circuit, so that they can exchange all the electrons necessary for the redox process of interest with it. Typically, the exchange of electrons between the “active sites” of each electrocatalytic layer and the external circuit is very simple. This happens because the electrocatalyst materials providing these “active sites” are made with highly conductive components endowed with a high electrical conductivity, such as platinum and carbon nanoparticles.

On the other hand, the reactants and products transport phenomena in an electrocatalytic layer involve species that, being ionic (for example, H₃O⁺) or neutral (for example, H₂, O₂ and H₂O) species, are much more massive than electrons. The main transport problems occur in the FC electrode where the recombination of ionic species takes place. This happens because the evolution of products of the reaction used to make the system work occurs in this electrode. In the case of FCs operating at low temperatures, such as for example conventional PEMFCs and AEMFCs, this product consists of liquid water. In the case of PEMFCs, the electrode where the water is produced is the cathode; while in the case of AEMFCs, the electrode where the water is produced is the anode. The latter, if not properly removed, leads to flooding phenomena that “suffocate” the “active sites”, thus inhibiting their operation, mainly since the gaseous reagents, such as hydrogen and oxygen, have difficulties in reaching the “active sites” by diffusion if these are covered by liquid water. This problem is particularly relevant when the FC produces large amounts of current, since in these conditions the evolution of liquid water is high.

To facilitate removal of liquid water, it is necessary that the “active sites” are well exposed to the external environment. To achieve this objective, it is necessary to check the morphology of the electrocatalysts supplying them, for example by making sure that these “active sites” are characterized by being highly “accessible” to reagents and products.

Electrocatalyst materials commonly adopted in the prior art have numerous limitations. In particular, electrocatalyst materials of the prior art are obtained with approaches aimed at coating a pre-existing support (typically based on carbonaceous materials such as carbon black) with platinum-based nanoparticles which are coated with active sites apt to promote the process of interest. These approaches lead to electrocatalysts with high performances, but typically characterized by poor durability since the interactions that are established between the support and the platinum-based nanoparticles are very weak. Therefore, as a result of the electrocatalyst operation, the platinum-based nanoparticles: (i) detach; (ii) undergo aggregation phenomena; and (iii) expel any other possible elements present (typically, metals of the first transition series such as Ni and Co) capable of increasing the “active sites” performances. Ultimately, all these degradative phenomena drastically reduce the electrocatalyst activity in promoting the process of interest.

There are numerous approaches to obtain electrocatalyst materials with improved performances and durability. In particular, the international application WO2017/055981 describes a preparative approach leading to carbonitride-based electrocatalysts with a “core-shell” morphology, that allows to establish very strong interactions between the “active sites” and the support. On the other hand, as regard to the morphology of the prior art electrocatalysts, the morphology of carbonitride-based electrocatalysts endowed with a “core-shell” morphology is very different. In the latter, the electrocatalyst grains are larger, as the various grains of the materials used as support are joined together by the carbonitride “shell”.

Therefore, the surface of the electrocatalytic layer is usually definitely as rougher than the one characterizing the electrocatalytic layers comprising the prior art electrocatalysts. This roughness hinders the establishment of a continuous and homogeneous interface between the ion-exchange membrane and the electrocatalytic layer, thus inhibiting the migration of the ionic species necessary for the FC operation.

Furthermore, the active sites of the electrocatalysts described in the patent application WO2017/055981 are not “applied from the outside” on the support, as in the case of the prior art electrocatalyst materials, but they “grow from the inside” in the carbonitride “shell”, and they are therefore not necessarily fully exposed to the external environment. Therefore, many of the “active sites” are not actually used (being unreachable by the reactants of the process of interest) or are located on the bottom of very narrow and tortuous pores of the carbonitride “shell” (and in this way the difficult transport of reagents and products significantly lowers also the efficiency of the electrocatalyst).

US2005/112448 describes an ion-exchange polymer that is used as an adhesion layer to minimize detachment of the electrodes from the membrane. Said detachment could in fact cause inefficiency of the cell.

US2010/068592 describes an ion-exchange polymer that is used to solve the compatibility issue between the ion-exchange polymeric membrane of the hydrocarbon type and the optimized electrodes for DMFC.

Definitions

Unless otherwise defined, all terms of the art, notations, and other scientific terms used herein are intended to have the meanings commonly understood by those skilled in the art to which this description belongs. In some cases, terms with meanings that are commonly understood are defined herein for clarity and/or ready reference; therefore, the inclusion of such definitions in the present description should not be construed as being representative of a substantial difference with respect to what is generally understood in the art.

The terms “approximately” and “about” used in the text refer to the range of the experimental error that is inherent in the execution of an experimental measurement.

The terms “ambient temperature” refers to a temperature comprised between 15° C. and 25° C.

The terms “comprising”, “having”, “including” and “containing” are to be construed as open-ended terms (i.e., meaning “comprising, but not limited to”), and are to be considered as a support also for terms such as “consist essentially of”, “consisting essentially of”, “consist of”, or “consisting of”.

The terms “consists essentially of”, “consisting essentially of” are to be construed as semi-closed terms, meaning that no other ingredients affecting the novel features of the invention are included (optional excipients may therefore be included).

The terms “consists of”, “consisting of” are to be construed as closed terms.

### SUMMARY OF THE INVENTION

The problem underlying the present invention is to overcome the disadvantages identified above, thus providing the final membrane-electrode assembly (MEA) with improved performances.

The approach of the present invention therefore allows to: (i) improve the mutual compatibility among the various layers comprising the MEA, by facilitating the migration of ionic species; and (ii) improve the accessibility of the electrocatalyst active sites to reagents and products of the electrochemical processes necessary for the MEA operation.

Therefore, the present invention relates, in a first aspect thereof, to a membrane-electrode assembly (MEA) according to claim 1; preferred features of the method are reported in the dependent claims.

More specifically, the membrane-electrode assembly comprises:
an anode and a cathode facing each other;
an ion-exchange membrane placed between the anode and the cathode;
an electrocatalytic coating layer applied on both sides of said ion-exchange membrane;
an ion-exchange polymer layer placed between said membrane and at least one of the electrocatalytic layers;
   characterized in that said electrocatalytic layer comprises micropores having an average diameter comprised between 0.001 and 50 micrometers, preferably between 0.01 and 1 micrometers and/or said electrocatalytic layer contains electrocatalyst particles having an average diameter comprised between 0.01 and 10 micrometers, preferably between 0.03 and 0.3 micrometers.

The membrane-electrode assembly (MEA) of the present invention allows to simultaneously satisfy the following two conditions: (i) establishing a good electrical contact between the active sites of the electrocatalyst and the external electrical circuit; and (ii) having good ionic contact between the active sites of the electrocatalyst and the ion conductive membrane that separates the two electrodes. Advantageously, the ion-exchange polymer layer is able to “establish an ionic bridge” between the membrane and the electrocatalytic layer by improving the transport of ionic species between the electrocatalytic layer and the ion-exchange membrane. Advantageously, the introduction of a suitable “pore-forming agent” in the electrocatalytic layer, allows the formation of cavities in the electrocatalytic layer which: (i) facilitate the distribution of reagents in the electrocatalytic layer; and (ii) facilitate the removal of products from the electrocatalytic layer.

Advantageously, reducing the electrocatalysts particle size by means of a grinding process of the electrocatalyst in the presence of a suitable “grinding agent” facilitates the exposure of the active sites and therefore the reagents and products transport phenomena, as well as the formation of a continuous and homogeneous interface between the ion-exchange membrane and the electrocatalytic layer.

The different embodiments of the present invention may be used individually or simultaneously in the manufacture of a MEA.

In accordance with a second aspect thereof, the present invention relates to a method of producing the membrane-electrode assembly described above comprising the steps of:

a) providing a dispersion of an ion-exchange polymer in a protic polar solvent or in a solution comprising more than one protic polar solvent;

b) applying said dispersion on an ion-exchange membrane or on at least one electrocatalytic layer applied on said membrane by means of (i) direct application on said membrane or on said at least one electrocatalytic layer, or (ii) application on an inert substrate followed by transfer on said membrane or on said at least one electrocatalytic layer, to form a membrane-polymeric layer system or an electrocatalytic layer-polymeric layer system;

c) removing the solvent, preferably by evaporation, vacuum evaporation, or drying;

d) optionally, subjecting said membrane-polymeric layer system or said electrocatalytic layer-polymeric layer system to pressing and/or treatment with at least one acid or basic aqueous solution.

In the case where the electrocatalytic layer comprises micropores, the method of producing the MEA according to the present invention further comprises the step of introducing in the electrocatalytic layer at least one pore-forming agent, and the subsequent step of removing said at least one pore-forming agent from the electrocatalytic layer.

In the case where the electrocatalytic layer contains electrocatalyst particles having an average diameter comprised between 0.01 and 10 micrometers, preferably between 0.03 and 0.3 micrometers, the method of producing the MEA of the present invention, further comprises the steps of:

grinding said electrocatalyst in the presence of at least one grinding agent; and

removing said at least one grinding agent from said electrocatalyst.

In accordance with a third aspect thereof, the present invention relates to a membrane-electrode assembly obtainable from the methods according to the invention described above.

In accordance with a fourth aspect thereof, the present invention relates to a fuel cell comprising the membrane-electrode assembly described above.

### BRIEF DESCRIPTION OF THE FIGURES

Further features and advantages of the invention will become clearer from the following description of some of the preferred embodiments thereof, provided below for illustrative and non-limiting purposes, with reference to the attached drawings. In such drawings:

FIG. 1 describes polarization curves related to MEA 1 and MEA 2. Experimental measurement conditions: T_{anode/cell/cathode}=84/85/84° C.; the anode is fed with pure hydrogen at a flow rate of 800 sccm; the cathode is fed either with pure oxygen at a flow rate of 500 sccm or with air at a flow rate of 1700 sccm. The relative humidity of all gaseous reagents is equal to 100%. The back pressure of the gaseous reagents is equal to 0.45 MPa;

FIG. 2 describes polarization curves related to MEA 3 and MEA 4. Experimental measurement conditions: T_{anode/cell/cathode}=84/85/84° C.; the anode is fed with pure hydrogen at a flow rate of 800 sccm; the cathode is fed either with pure oxygen at a flow rate of 500 sccm or with air at a flow rate of 1700 sccm. The relative humidity of all gaseous reagents is 1 equal to 100%. The back pressure of the gaseous reagents is equal to 0.10 MPa;

FIG. 3 is a photo of the RRDE tip coated by the deposited and dried layer containing EC PtNi1. This EC is provided by means of the “original PtNi1” mixture (a) or by means of the “treated PtNi1” mixture (b) according to the present invention;

FIG. 4 describes the RDE profiles of EC PtNi1. This EC is provided by means of the “original PtNi1” mixture or by means of the “treated PtNi1” mixture according to the present invention;

FIG. 5 is a photo of the RRDE tip coated by the deposited and dried layer containing EC PtCu1. This EC is provided by means of the “original PtCu1” mixture (a) or by means of the “treated PtCu1” mixture (b) according to the present invention;

FIG. 6 describes the RDE profiles of EC PtCu1. This EC is provided by means of the “original PtCu1” mixture or by means of the “treated PtCu1” mixture according to the present invention;

FIG. 7 describes polarization curves related to MEA 5 and MEA 6. Experimental measurement conditions: T_{anode/cell/cathode}=84/85/84° C.; the anode is fed with pure hydrogen at a flow rate of 800 sccm; the cathode is fed either with pure oxygen at a flow rate of 500 sccm or with air at a flow rate of 1700 sccm. The relative humidity of all gaseous reagents is equal to 100%. The back pressure of the gaseous reagents is equal to 0.45 MPa.

### DETAILED DESCRIPTION OF THE INVENTION

In a first aspect thereof, the present invention relates to a membrane-electrode assembly (MEA) comprising:

an anode and a cathode facing each other;

an ion-exchange membrane placed between the anode and the cathode;

an electrocatalytic coating layer applied on both sides of said ion-exchange membrane;

an ion-exchange polymer layer placed between said membrane and at least one of the electrocatalytic layers;

characterized in that said electrocatalytic layer comprises micropores having an average diameter comprised between 0.001 and 50 micrometers, preferably between 0.01 and 1 micrometers and/or said electrocatalytic layer contains electrocatalyst particles having an average diameter comprised between 0.01 and 10 micrometers, preferably between 0.03 and 0.3 micrometers.

An aspect of the present invention consists in the introduction of an ion-exchange polymer layer, referred to as “StratIon”, between the ion-exchange membrane included in a MEA, referred to as “Membr”, and at least one of the electrocatalytic layers in contact with it. The introduction of such StratIon facilitates establishing good ion conduction between Membr and the active sites comprised within the electrocatalytic layer.

Said ion-exchange polymer is selected from the group comprising an ionomer apt to exchange: (i) cations; (ii) anions; or (iii) both anions and cations.

Examples of cationic ionomers that may be used in the present invention are the perfluorosulfonated ones (PFSA ionomers), such as for example Nafion, Aquivion or Hyflon-Ion.

It is, however, possible to use any other polymer functionalized with cation-exchange groups (for example, —SO₃⁻, —ClO₃⁻, and the like). It is also possible to use an ionomer apt to exchange anions, including polymers functionalized with —N(CH₃)₃⁺, pyridine, or similar groups. Finally, it is possible to use ionomers bearing simultaneously groups capable of exchanging cations and groups capable of exchanging anions.

According to a preferred embodiment, the StratIon thickness is comprised between 2 and 1,000 micrometers, preferably comprised between 2 and 50 micrometers.

In a further preferred embodiment of the present invention, the electrocatalytic layer comprises an electrocatalyst, preferably a carbonitride-based electrocatalyst having a “core-shell” morphology or an electrocatalyst comprising graphene oxide, graphene nitride, graphene, or graphene functionalized with —COOH and/or —OH groups. Examples of electrocatalysts that may be used in the present invention are those carbonitride-based and having a “core-shell” morphology described for example in patent application WO2017/055981.

Examples of catalysts comprising graphene oxide, graphene nitride, graphene, or graphene functionalized with —COOH and/or —OH groups are those described in patent application WO2018/122368.

StatIon can therefore be obtained according to one of the following approaches: (i) direct application on Membr or on the electrocatalytic layer; (ii) “ex-situ” preparation followed by transfer onto Membr; and (iii) “ex-situ” preparation followed by transfer onto the electrocatalytic layer.

In accordance with a second aspect thereof, the present invention relates to a method of producing the membrane-electrode assembly described above comprising the steps of:

a) providing a dispersion of an ion-exchange polymer in a protic polar solvent or in a solution comprising more than one protic polar solvent;

b) applying said dispersion on an ion-exchange membrane or on at least one electrocatalytic layer applied on said membrane by means of (i) direct application on said membrane (for example, by hand brushing, or by “ink-jet” printing) or on said at least one electrocatalytic layer, or (ii) application on an inert substrate (for example, a Teflon™ sheet), followed by transfer on said membrane or on said at least one electrocatalytic layer, to form a membrane-polymeric layer system or an electrocatalytic layer-polymeric layer system;

c) removing the solvent, preferably by evaporation, vacuum evaporation, or drying;

d) optionally, subjecting said membrane-polymeric layer system or said electrocatalytic layer-polymeric layer system to pressing and/or treatment with at least one acid or basic aqueous solution.

The polar protic solvents that may be used in step a) of the method according to the invention, are selected from C₁-C₄, alcohols, water, or carboxylic acids. Preferably, C₁-C₄ alcohols.

It is also possible to use a solution comprising more than one solvent (for example, water and isopropyl alcohol.

In the following EXAMPLE 1, MEA 1 is made by introducing StatIon between the ion-exchange membrane and the cathode electrocatalytic layer. It is observed how MEA 1 performances result to be much better than those of MEA 2 (MEA 2 is identical to MEA 1, with the only difference that it does not comprise the StratIon layer). Based on these results, it is concluded that the introduction of an ion-exchange polymer layer between the electrocatalytic layer and the ion-exchange membrane results in a significant increase in the MEA performances due to improvement of the ionic contact between membrane and active sites, thus obtaining a clearly ameliorative effect.

A further aspect of the present invention consists in the formation of micropores, having an average diameter comprised between 0.001 and 50 micrometers, preferably between 0.01 and 1 micrometers, in the electrocatalytic layers of a MEA. This aspect is implemented by introducing an appropriate “pore-forming agent” in the ink formulation used to obtain an electrocatalytic layer.

The pore-forming agent is a material which, as a result of appropriate treatments, is removed from the electrocatalytic layer leaving cavities that increase the interface area between the electrocatalyst material and the external environment, through which the reagents of the process promoted by the electrocatalyst material itself are provided.

The method of producing the MEA according to the invention may comprise the step of introducing at least one pore-forming agent into the electrocatalytic layer, and the subsequent step of removing said at least one pore-forming agent from the electrocatalytic layer.

In a preferred embodiment, the ratio between the volume of the pore-forming agent introduced into the electrocatalytic layer and the volume of the electrocatalytic material contained in the same layer ranges between 10 and 0.01, preferably between 1 and 0.1.

Typical examples of pore-forming agent that may be used in the present invention are solids readily soluble in water (for example, alkali or alkaline-earth metal halides such as LiBr, NaI, and CaCl₂) or solids readily soluble in weakly acid aqueous solutions (metal oxides such as ZnO, TiO₂, SiO₂ or inorganic salts of alkaline or alkaline-earth metals, such as for example carbonates CaCO₃, sulfates, nitrates, phosphates) or a mixture thereof.

In a preferred embodiment, the pore-forming agent consists of particles with an average diameter comprised between 10,000 and 2 nm, preferably comprised between 200 and 20 nm.

The pore-forming agent may be introduced in the electrocatalytic layer simply by dispersing the components thereof in the ink used to obtain the same electrocatalytic layer. Alternatively, it is possible to combine the various components of the pore-forming agent (for example, by grinding) before introducing them in the ink. The ink containing the pore-forming agent is treated like any other ink suitable for the production of electrocatalytic layers. Therefore, this ink may be applied on the electrodes of a MEA (“catalyst-coated substrate” procedure, CCS) or on an ion-exchange membrane (for example by decal, in a “catalyst-coated membrane” procedure, CCM). At this point, once the liquid phase of the ink has been removed (typically by evaporation), it is necessary to remove the pore-forming agent from the resulting electrocatalytic layer.

This removal is generally carried out by (i) washing with an acid or basic aqueous solution, optionally in the presence of at least one gas bubbled through the aqueous solution; (ii) vacuum sublimation; (iii) ultrasound treatment; (iv) decantation; (v) filtration; (vi) addition of appropriate additives followed by flotation; (vii) treatment with a non-polar organic solvent, such as toluene, hexane, heptane, benzene, or a mixture thereof; (viii) treatment with an aprotic polar solvent, such as dimethylformamide, dimethylacetamide, N-methylpyrrolidone, tetrahydrofuran, or a mixture thereof; or (ix) treatment with aldehydes, ketones, carboxylic acids, amines, or a mixture thereof.

In the following EXAMPLE 2, an ink comprising ZnO is made. This last component acts as a pore-forming agent. The electrocatalytic layer comprising this agent is then repeatedly treated with acid aqueous solutions in order to remove: (i) the pore-forming agent itself; and (ii) Zn²⁺ ions produced by its dissolution, that are therefore completely removed from the system. MEAs made in EXAMPLE 2 also include a ion-exchange polymer layer between the ion-exchange membrane comprised in each MEA, and at least one of the electrocatalytic layers in contact with it.

At the end of this process of making the MEAs, it is noted that performances of MEA 3 (wherein one of the electrocatalytic layers comprised the pore-forming agent) are much better than those of MEA 4 (wherein no pore-forming agent was added). It is therefore concluded that the addition of an appropriate pore-forming agent results in a clearly ameliorative effect on MEA performances.

A further aspect of the present invention consists in carrying out an extensive grinding of the electrocatalyst material, that is carried out by combining the electrocatalyst material itself with a suitable “grinding agent”, in order to obtain an electrocatalytic layer containing electrocatalyst particles having an average diameter comprised between 0.01 and 10 micrometers, preferably between 0.03 and 0.3 micrometers.

This grinding agent typically consists of powders of hard but fragile materials, such as for example metal oxides. Typical examples of such materials are systems such as ZnO, TiO₂, SiO₂.

It is also possible to use alkali or alkaline-earth metal halides (LiBr, NaI, and CaCl₂), inorganic salts of alkali or alkaline-earth metals such as carbonates, sulfates, nitrates, phosphates, or a mixture thereof.

The grinding procedure in the presence of this grinding agent serves in the first instance to reduce the size of the electrocatalyst grains. In this way, the surface area of the electrocatalyst is increased, while improving the accessibility of the active sites thereof.

The method of producing the MEA according to the invention may include the step of grinding the electrocatalyst in the presence of at least one grinding agent and the subsequent step of removing said at least one grinding agent from said electrocatalyst.

In a preferred embodiment, the ratio between the volume of the grinding agent and the overall volume of the material to be ground (the latter comprising the electrocatalyst and, optionally, further components such as carbonaceous materials such as carbon black) may range between 10 and 0.01, preferably between 1 and 0.1.

The size of the grinding agent particles may range between 1 mm and 2 nm, preferably between 100 and 10 nm.

In a preferred embodiment of the grinding step, the duration of the process in the presence of at least one grinding agent ranges from 20 minutes to 400 hours, preferably between 30 minutes and 1 hour.

Optionally, it is possible to carry out the grinding process in the presence of a grinding agent by adding a suitable liquid to the mixture under grinding. Such liquids comprise water, alcohols, aldehydes, ketones, ethers, esters, hydrocarbons, amines, amides, or mixtures thereof. It is possible to add the liquid at the beginning of the process, or at any time during the grinding. It is also possible to add liquids of different composition at different times of the grinding process.

The grinding agent may consist of one or more different components. Each component of the grinding agent may be added to the mixture under grinding at any time during the grinding process.

The grinding process in the presence of the grinding agent may be carried out at a temperature comprised between −270° C. and 1,700° C., preferably between −195° C. and 200° C., more preferably at ambient temperature. It is possible to modulate the temperature at will during the grinding process in the presence of the grinding agent.

The grinding process in the presence of the grinding agent may be carried out in the presence of electric and/or magnetic fields of desired intensity and variable over time as desired.

At the end of the grinding process in the presence of the grinding agent it is possible to remove the same grinding agent from the system.

This removal treatment may be carried out by means of one or more of the following processes: (i) washing with suitable liquid phases (for example, acid or basic aqueous solutions), possibly in the presence of suitable gases bubbled through the same liquid phase; (ii) vacuum sublimation; (iii) ultrasound treatment; (iv) decantation; (vi) filtration; (vi) addition of appropriate additives followed by flotation; (vii) treatment with a non-polar organic solvent, such as toluene, hexane, heptane, benzene, or a mixture thereof; (viii) treatment with an aprotic polar solvent, such as dimethylformamide, dimethylacetamide, N-methylpyrrolidone, tetrahydrofuran, or a mixture thereof; (ix) treatment with aldehydes, ketones, carboxylic acids, amines, or a mixture thereof.

In the following EXAMPLE 3 and EXAMPLE 4, a mixture was prepared using as grinding agent some ZnO nanoparticles with a diameter equal to 50 nm. The mixture resulted to be homogeneous and stable, and allowed to make very homogeneous layers on the disc of a RRDE tip. These layers are much more homogeneous than the layers obtained without addition of ZnO. These tips are used in CV-TF-RRDE (Cyclic Voltammetry Thin-Film Rotating Ring-Disk Electrode) studies carried out in an acid environment which removes the ZnO nanoparticles present in the mixture deposited on the RRDE tip. The CV-TF-RRDE studies show that the treatments described in EXAMPLE 3 and EXAMPLE 4 according to the invention, do not alter the active sites of the electrocatalyst while improving accessibility of these active sites to reagents or products, resulting in a clearly ameliorative effect.

In the following EXAMPLE 5, a mixture was prepared using as grinding agent some ZnO nanoparticles with a diameter equal to 50 nm. The mixture resulted to be homogeneous and stable, and allowed to make a very homogeneous electrocatalytic layer. The latter was then repeatedly treated with acid aqueous solutions that removed both the grinding agent and by-products of its dissolution, with particular reference to Zn²⁺. It should be noted that, in this specific EXAMPLE 5, ZnO simultaneously plays the following two roles: (i) “grinding agent”, as it reduces the particle size of the electrocatalyst particles introduced into the electrocatalytic layer; and (ii) “pore-forming agent”, since once removed it leaves cavities inside the electrocatalytic layer that improve the reagents distribution and removal of the products of the process of interest promoted by the electrocatalyst (in this case, the oxygen reduction reaction that leads to formation of water).

The aspects of the invention listed above, namely (i) introduction of an ion-exchange polymer layer between the membrane and at least one electrocatalytic layer, (ii) formation of micropores in the electrocatalytic layer, or (iii) reduction of the electrocatalyst particle size, may be used individually or simultaneously in the manufacture of a MEA.

Even the methods of producing MEAs according to the invention may be used individually or in association with each other.

In accordance with a third aspect thereof, the present invention relates to a membrane-electrode assembly obtainable by the methods according to the invention described above.

In accordance with a fourth aspect thereof, the present invention relates to a fuel cell comprising the membrane-electrode assembly described above.

### EXAMPLE 1

This EXAMPLE 1 relates to the EC referred to as “PtNi2”. EC PtNi2 was prepared as described in patent applications WO2017/055981 and WO2018/122368. PtNi2 comprises 6.93% by weight of Pt and 1.43% by weight of Ni.

The production of the MEA comprising EC PtNi2 is carried out as follows.

A total of 250 microliters of a 5% by weight dispersion of Nafion in alcohols are applied onto a Teflon™ sheet forming a square of area equal to 5 square centimeters. The solvent is then removed by drying at 90° C., thus forming a Nafion layer deposited on the Teflon layer. This layer is referred to as “StratIon”.

The StratIon layer is transferred by decal on a dry proton exchange membrane with a thickness of 15 microns and having a proton exchange capacity equal to 2.94 milliequivalents per gram, referred to as “Membr”. This transfer is carried out by means of a hot-pressing procedure, bringing the system to 146° C. for 5 minutes and adopting a pressure of 3.45 MPa. The resulting product is referred to as “Membr+StratIon”.

Membr+StratIon is subjected to the following activation procedure: (i) washing with bidistilled water at 80° C. for 1 hour; (ii) washing with 3% H₂O₂ at 80° C. for 1 hour; (iii) two washings with 1 M H₂SO₄ at 80° C. for 1 hour; (iv) one washing with bidistilled water at 80° C. for 1 hour. Membr+StratIon is then dried by a dry air flow for 24 hours before use in the MEA production.

20 mg of PtNi2 and 10 mg of Vulcan XC-72R carbon black are combined and intensely ground together; the resulting mixture is then placed in a vial into which 200 microliters of double-distilled water and, subsequently, 1 milliliter of isopropyl alcohol are then added. The resulting suspension is intensely sonicated by means of a tip sonicator; 366 microliters of a 5% by weight dispersion of Nafion in alcohols are then added to the suspension. This suspension is intensely sonicated by means of a tip sonicator; the resulting product is a suspension referred to as “SospCat”.

20 mg of a reference EC comprising 20% by weight of platinum, referred to as “Pt/C ref. 2”, in a vial into which 200 microliters of double distilled water and, subsequently, 1 milliliter of isopropyl alcohol are then added. The resulting suspension is intensely sonicated by means of a tip sonicator; 206 microliters of a 5% by weight dispersion of Nafion in alcohols are then added to the suspension. This suspension is extensively sonicated by means of a tip sonicator; the resulting product is a suspension referred to as “SospAn”.

A SospCat aliquot is deposited on the microporous layer of a 2×2 cm sized Teflon-coated carbon paper electrode so that the total platinum loading on the electrode is equal to 0.05 milligrams of platinum per square centimeter of electrode. For this to happen, the weight of the solid deposited on the electrode, obtained by drying the SospCat suspension, should be equal to 6.78 mg. The resulting electrode is referred to as “PtNi2 cathode”.

A SospAn aliquot is deposited on the microporous layer of a 2×2 cm sized Teflon-coated carbon paper electrode so that the overall platinum loading on the electrode is equal to 0.4 milligrams of platinum per square centimeter of electrode. For this to happen, the weight of the solid deposited on the electrode, obtained by drying the SospAn suspension, should be equal to 11.84 mg. The resulting electrode is referred to as “Pt/C ref. 2 anode”.

The two Pt/C ref. 2 anode and PtNi2 cathode electrodes are hot-pressed on to Membr+StratIon. The layer comprising EC PtNi2 deposited on the PtNi2 cathode electrode is placed in direct contact with the StratIon layer. The layer comprising EC Pt/C ref. 2 deposited on the Pt/C ref. 2 anode electrode is placed in direct contact with the other face of Membr+StratIon. The hot-pressing procedure is carried out at a temperature of 146° C. and at 2.76 MPa; these parameters are maintained for 5 min. At the end of this step, the MEA referred to as MEA1 is obtained.

A second reference MEA, referred to as MEA2, is prepared. MEA2 is absolutely identical to MEA1, with the only difference that MEA2 does not comprise the StratIon layer.

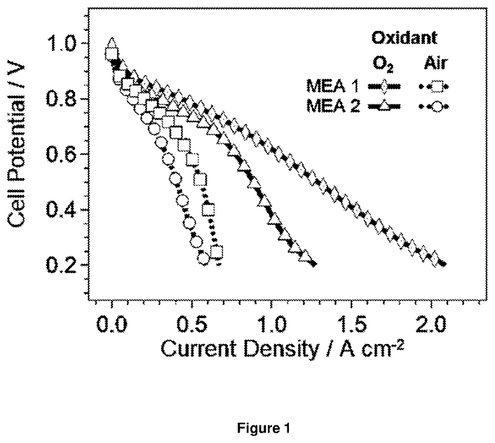

MEA1 and MEA2 are tested in single cell. The corresponding polarization curves are shown in FIG. 1.

It has to be noted how the introduction of the StratIon layer between Membr and the electrocatalytic layer comprising EC PtNi2, and deposited on the PtNi2 cathode, significantly improves the MEA performances.

### EXAMPLE 2

This EXAMPLE 2 refers to the same EC used in EXAMPLE 1.

The production of the MEA comprising EC PtNi2 is carried out as follows.

A total of 250 microliters of a 5% by weight dispersion of Nafion in alcohols is applied onto a Teflon™ sheet forming a square of area equal to 5 square centimeters. The solvent is then removed by drying at 90° C., thus forming a Nafion layer deposited on the Teflon layer. This layer is referred to as “StratIon”.

The StratIon layer is transferred by decal on a dry proton exchange membrane with a thickness of 15 microns and having a proton exchange capacity equal to 2.94 milliequivalents per gram, referred to as “Membr”. This transfer is carried out by means of a hot-pressing procedure, bringing the system to 130° C. for 5 minutes and adopting a pressure of 5.52 MPa. The resulting product is referred to as “Membr+StratIon”.

Membr+StratIon is subjected to the following activation procedure: (i) washing with bidistilled water at 80° C. for 1 hour; (ii) washing with 3% H₂O₂ at 80° C. for 1 hour; (iii) two washings with 1 M H₂SO₄ at 80° C. for 1 hour; (iv) and one washing with bidistilled water at 80° C. for 1 hour. Membr+StratIon is then dried by a dry air flow for 24 hours before use in the MEA production.

20 mg of PtNi2 and 10 mg of Vulcan XC-72R carbon black are combined and intensely ground together; the resulting mixture is then placed in a vial into which 200 microliters of double-distilled water and, subsequently, 1 milliliter of isopropyl alcohol are then added. 22.95 mg of ZnO are also added to the suspension in the form of nanoparticles having an average diameter of 50 nm. The resulting suspension is intensely sonicated by means of a tip sonicator; 366 microliters of a 5% by weight dispersion of Nafion in alcohols are then added to the suspension. This suspension is intensely sonicated by means of a tip sonicator; the resulting product is a suspension referred to as “SospCat”.

20 mg of a reference EC comprising 20% by weight of platinum, referred to as “Pt/C ref. 2”, are placed in a vial into which 200 microliters of double distilled water and, subsequently, 1 milliliter of isopropyl alcohol are then added. The resulting suspension is intensely sonicated by means of a tip sonicator; 206 microliters of a 5% by weight dispersion of Nafion in alcohols are then added to the suspension. This suspension is extensively sonicated by means of a tip sonicator; the resulting product is a suspension referred to as “SospAn”.

10.09 mg di SospCat are applied on to a Teflon sheet forming a 2×2 cm square. The solvent is then removed by drying at 90° C., thus forming a layer deposited on the Teflon layer. This layer is referred to as “EletCat”.

The EletCat layer is transferred by decal on the Membr+StratIon face with the StratIon layer. Specifically, the EletCat is made to position completely within the StratIon layer. This transfer is carried out by means of a hot-pressing procedure, bringing the system to 130° C. for 5 minutes and adopting a pressure of 5.52 MPa. The resulting product is referred to as “Membr+StratIon+EletCat”.

Membr+StratIon+EletCat is treated for 1 hour with a 0.5 M HNO₃ solution at ambient temperature. This treatment is repeated 3 times. Then, Membr+StratIon+EletCat is washed for 20 minutes with bidistilled water at ambient temperature. This treatment is repeated 2 times. Membr+StratIon+EletCat is then dried by a dry air flow for 24 hours.

A SospAn is painted on the microporous layer of a 2×2 cm sized Teflon-coated carbon paper electrode so that the total platinum loading on the electrode is equal to 0.4 milligrams of platinum per square centimeter of electrode. For this to happen, the weight of the solid deposited on the electrode, obtained by drying the SospAn suspension, should be equal to 11.84 mg. The resulting electrode is referred to as “Pt/C ref. 2 anode”.

The Pt/C ref. 2 anode electrode is placed in direct contact with the face of Membr+StratIon+EletCat on which the StratIon and EletCat layers have not been transferred to. A 2×2 cm sized square of Teflon-coated carbon paper with a microporous layer is instead applied on the other face of Membr+StratIon+EletCat, that is the one where the StratIon and EletCat have been transferred to. Specifically, this microporous layer is placed in contact with the EletCat layer. The resulting system, consisting of the Pt/C ref. 2 anode electrode, the Membr+StratIon+EletCat and the 2×2 cm sized square of Teflon-coated carbon paper with a microporous layer is subjected to a hot-pressing process that is carried out at a temperature of 146° C. and 2.76 MPa; these parameters are maintained for 5 min. At the end of this step, the MEA referred to as MEA3 is obtained.

A second MEA, referred to as MEA4, is prepared. MEA4 is absolutely identical to MEA3, with the only difference that MEA4 does not comprise ZnO nanoparticles having a diameter of 50 nm in the EletCat layer.

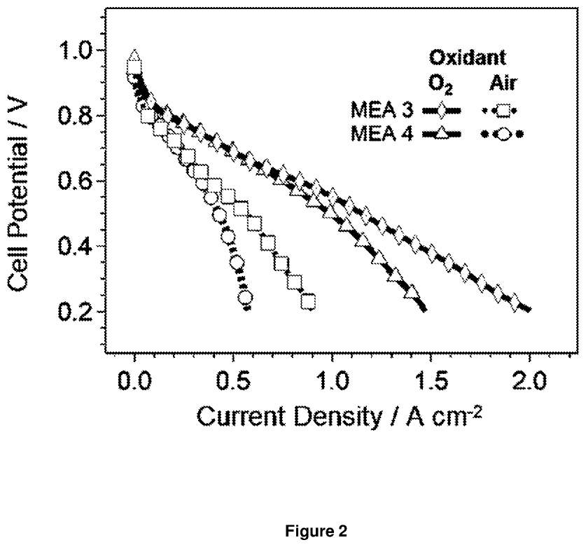

MEA3 and MEA4 were then tested in single cell. The corresponding polarization curves are shown in FIG. 2.

It is observed that the introduction of ZnO particles in EletCat, and their subsequent removal by acid treatment, considerably improves the maximum current density delivered by MEA 3. This result is attributed to the improvement of the accessibility of the active sites present in EletCat, which can be more easily reached by the reagents and are able to better expel the products, thus inhibiting the flooding phenomena.

### EXAMPLE 3

This EXAMPLE 3 relates to the EC referred to as “PtNi1”. EC PtNi1 was prepared as described in patent applications WO2017/055981 and WO2018/122368. PtNi1 comprises 9.0% by weight of Pt and 3.1% by weight of Ni. 50 mg of PtNi1 are mixed with 50 mg of Vulcan XC-72R carbon black. The mixture thus obtained is extensively ground in a mortar leading to a mixture referred to as “original PtNi1”. The preparation of this mixture is described in the scientific literature by V. Di Noto et al., Adv. Funct. Mater. 17 (2007) 3626-3638. A small aliquot of PtNi1 (of the order of 5 mg) is added to 76.5 mg of ZnO nanoparticles having an average diameter of 50 nm. The resulting mixture is intensively ground in a mortar. Subsequently, other small aliquots of PtNi1, are added to the resulting mixture, repeating the process (PtNi1 addition+mixture grinding) until the mixture contains a total of 50 mg of PtNi1. Subsequently, a total of 50 mg of Vulcan XC-72R carbon black are added to the mixture thus obtained; also in this case, the addition is performed in small aliquots, by intensely grinding the intermediate mixtures in a mortar. The final mixture, comprising a total of 50 mg of PtNi1, 50 mg of Vulcan XC-72R carbon black and 76.5 mg of ZnO nanoparticles having an average diameter of 50 nm, is referred to as “treated PtNi1”. Each mixture is then used to make an ink using a recipe described in the scientific literature by V. Di Noto et al., Adv. Funct. Mater. 17 (2007) 3626-3638.

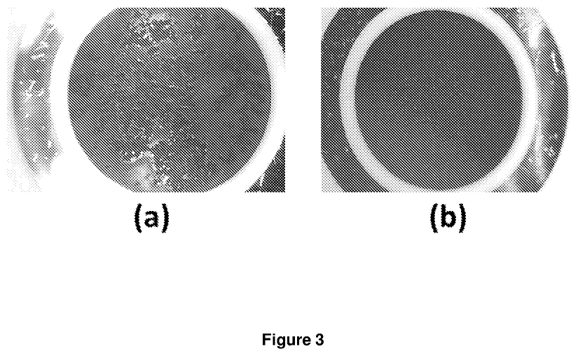

An appropriate aliquot of these inks is then deposited on an RRDE tip, making sure that the platinum loading on the RRDE tip disk is equal to 12 micrograms per square centimeter. The solvents are removed by the procedure described in the scientific literature by Y. Garsany et al., J. Electroanal. Chem. 662 (2011) 396-406 and P. J. Yunker et al., Nature 476 (2011) 308-311. At the end of this drying process, the RRDE tip has the appearance shown in FIG. 3.

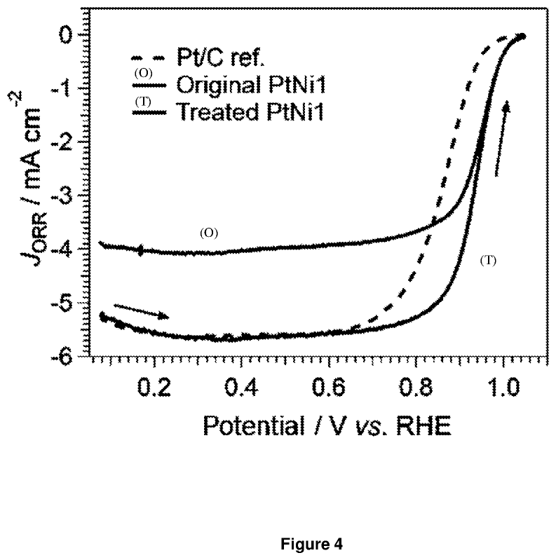

It should be noted how the deposited layer containing the “treated PtNi1” mixture is much more compact and homogeneous than the deposited layer containing the “original PtNi1” mixture. Each RRDE tip is used to carry out an “ex-situ” measurement of EC performances using the CV-TF-RRDE methodology; the latter is described in the scientific literature by V. Di Noto et al., Adv. Funct. Mater. 17 (2007) 3626-3638 and V. Di Noto et al., Electrochim. Acta 280 (2018) 149-162. CV-TF-RRDE measurements are also carried out using a reference EC, referred to as “Pt/C ref.” and comprising 10% by weight of platinum. This EC is introduced in the ink with no further additions of either Vulcan XC-72R carbon black or additional solid components. The layer containing EC Pt/C ref. is deposited and dried on the RRDE tip disc as described above. The loading of platinum in this layer is equal to 12 micrograms per square centimeter. All RRDE measurements are collected at T=25° C. and by rotating the RRDE tip at 1,600 rpm. The corresponding results are shown in FIG. 4.

It is noted how, when the current density in the ORR (referred to as J_{ORR} in FIG. 4) is lower (in absolute value) than about −1.5 mA cm⁻², the two profiles coincide. On the other hand, the maximum J_{ORR} obtained with the “treated PtNi1”, equal to about −5.7 mA cm⁻² is significantly higher (in absolute value) than the maximum J_{ORR} obtained with the “original PtNi1”, mixture, being instead equal to about −4 mA cm⁻². This result depends on the fact that the maximum J_{ORR} is directly proportional to the area of the RRDE tip disc actually coated by the EC. This area is higher in the case of the deposited and dried layer containing the “treated PtNi1” mixture (see FIG. 3(b)) compared to the deposited and dried layer containing the “original PtNi1” mixture (see FIG. 3(a)). In fact, in the latter case, a large area of the RRDE tip disc is not coated by the mixture containing the EC.

The results presented in this EXAMPLE 3 show that the present invention allows to obtain a mixture comprising EC PtNi1 characterized by a high homogeneity. Furthermore, the preparation procedure described herein does not negatively affect EC PtNi1 performances in the ORR and has no detrimental effect on the number and chemical nature of the active sites present in the same EC.

### EXAMPLE 4

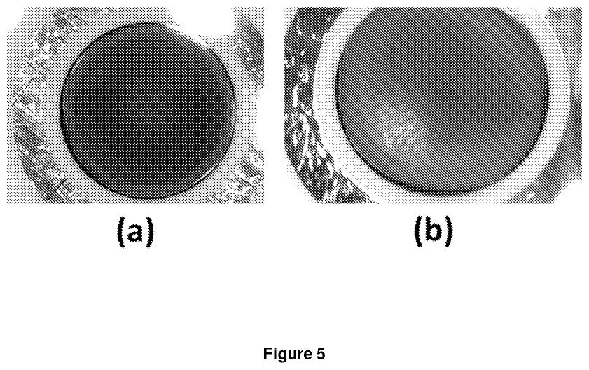

This EXAMPLE 4 relates to the EC referred to as “PtCu1”. EC PtCu1 was prepared as described in patent applications WO2017/055981 and WO2018/122368. PtCu1 comprises 29.5% by weight of Pt, 4.75% by weight of Cu and 0.055% by weight of Ni. 50 mg of PtCu1 are mixed with 50 mg of Vulcan XC-72R carbon black. The mixture obtained is extensively ground in a mortar, leading to the mixture referred to as “original PtCu1”. The preparation of this mixture is described in the scientific literature by V. Di Noto et al., Adv. Funct. Mater. 17 (2007) 3626-3638. A small aliquot of PtCu1 (of the order of 5 mg) is added to 58 mg of ZnO nanoparticles having an average diameter of 50 nm. The resulting mixture is extensively ground in a mortar. Subsequently, other small aliquots of PtCu1 are added, repeating the process (PtCu1 addition+mixture grinding) until the mixture contains a total of 50 mg of PtCu1. Subsequently, a total of 50 mg of Vulcan XC-72R carbon black are added to the mixture thus obtained; also in this case, the addition is performed in small aliquots, extensively grinding the intermediate mixtures in a mortar. The final mixture, comprising a total of PtCu1, 50 mg of Vulcan XC-72R carbon black and 58 mg of ZnO nanoparticles having an average diameter of 50 nm is referred to as “treated PtCu1”. Each mixture is then used to make an ink using a recipe described in the scientific literature by V. Di Noto et al., Adv. Funct. Mater. 17 (2007) 3626-3638. An appropriate aliquot of these inks is then deposited on an RRDE tip, making sure that the platinum loading on the RRDE tip disk is equal to 12 micrograms per square centimeter. The solvents are removed by the procedure described in the scientific literature by Y. Garsany et al., J. Electroanal. Chem. 662 (2011) 396-406 and P. J. Yunker et al., Nature 476 (2011) 308-311. At the end of this drying process, the RRDE tip has the aspect shown in FIG. 5.

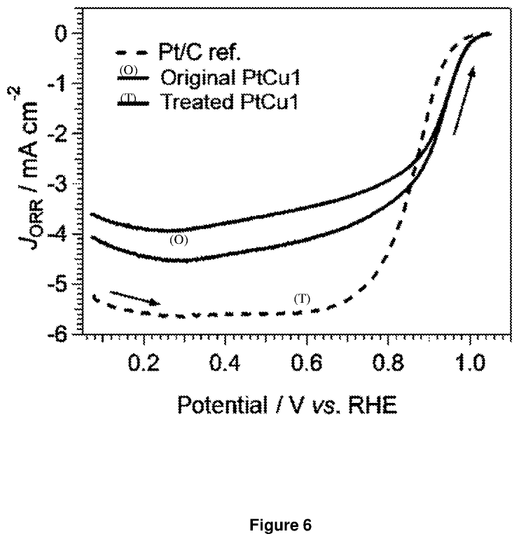

It should be noted that the deposited layer containing the “treated PtCu1” mixture is much more compact and homogeneous than the deposited layer containing the “original PtCu1” mixture, that has instead a ring morphology with a central area showing very poor content of the mixture. Each RRDE tip is used to carry out an “ex-situ” measurement of the EC performances using the CV-TF-RRDE methodology; the latter is described in the scientific literature by V. Di Noto et al., Adv. Funct. Mater. 17 (2007) 3626-3638 and V. Di Noto et al., Electrochim. Acta 280 (2018) 149-162. CV-TF-RRDE measurements were also carried out using a reference EC as described in EXAMPLE 3. All RRDE measurements are collected at T=25° C. and by rotating the RRDE tip at 1,600 rpm. The corresponding results are shown in FIG. 6.

It is noted how, when the current density in the ORR (referred to as J_{ORR} in FIG. 6) is lower (in absolute value) than about −1.5 mA cm⁻², the two profiles coincide. On the other hand, the maximum J_{ORR} obtained with the “treated PtCu1” mixture, equal to about −4.5 mA cm⁻² is significantly higher (in absolute value) than the maximum J_{ORR} obtained with the “original PtCu1” mixture, which is instead equal to about −3.9 mA cm⁻². This result depends on the fact that the maximum J_{ORR} is directly proportional to the area of the RRDE tip disc actually coated by the EC. This area is higher in the case of the deposited and dried layer containing the “treated PtCu1” mixture (see FIG. 5(b)) compared to the deposited and dried layer containing the “original PtCu1” mixture (see FIG. 5(a)). In fact, in the latter case a larger area of the RRDE tip disc is not coated by the mixture containing the EC.

The results presented in this EXAMPLE 4 are similar to those presented in EXAMPLE 3 and demonstrate that the present invention allows to obtain a mixture comprising the EC PtCu1 characterized by a high homogeneity. Furthermore, the preparation procedure described herein does not negatively affect EC PtCu1 performances in the ORR and has no detrimental effect on the number and chemical nature of the active sites present in the EC itself.

### EXAMPLE 5

This EXAMPLE 5 relates to the EC referred to as “PtNi3”. EC PtNi3 was prepared as described in patent applications WO2017/055981 and WO2018/122368. PtNi3 comprises 5.71% by weight of Pt and 3.32% by weight of Ni.

The production of the MEA comprising EC PtNi3 is carried out as follows.

A total of 250 microliters of a 5% by weight dispersion of Nafion in alcohols are applied onto a Teflon™ sheet forming a square of area equal to 5 square centimeters. The solvent is then removed by drying at 90° C., thus forming a layer of Nafion deposited on the Teflon layer. This layer is referred to as “StratIon”. Two distinct StratIon layers are produced on two distinct Teflon sheets.

The StratIon layers are transferred by decal on both faces of a dry proton exchange membrane with a thickness of 15 microns and having a proton exchange capacity equal to 2.94 milliequivalents per gram, referred to as “Membr”. This transfer is carried out by means of a hot-pressing procedure, bringing the system to 130° C. for 5 minutes and adopting a pressure of 5.52 MPa. The resulting product is referred to as “Membr+StratIon”.

Membr+StratIon is subjected to the following activation procedure: (i) washing with bidistilled water at 80° C. for 1 hour; (ii) washing with 3% H₂O₂ at 80° C. for 1 hour; (iii) two washings with 1 M H₂SO₄ at 80° C. for 1 hour; (iv) and one washing with bidistilled water at 80° C. for 1 hour. Membr+StratIon is then dried by a dry air flow for 24 hours before use in the production of the MEA.

20 mg of PtNi3, 10 mg of Vulcan XC-72R carbon black and 22.95 mg of ZnO nanoparticles having an average diameter of 50 nm are used to obtain a mixture, referred to as “treated PtNi3”, that is prepared following the procedure described in EXAMPLE 3 to obtain the mixture referred to as treated PtNi1. The resulting mixture is then placed in a vial into which 200 microliters of double-distilled water and, subsequently, 1 milliliter of isopropyl alcohol are then added. The resulting suspension is intensely sonicated by means of a tip sonicator; 364 microliters of a 5% by weight dispersion of Nafion in alcohols are then added to the suspension. This suspension is intensely sonicated by means of a tip sonicator; the resulting product is a suspension referred to as “SospCat”.

20 mg of a reference EC comprising 20% by weight of platinum, referred to as “Pt/C ref. 2”, are placed in a vial into which 200 microliters of double-distilled water and, subsequently, 1 milliliter of isopropyl alcohol are then added. The resulting suspension is intensely sonicated by means of a tip sonicator; 206 microliters of a 5% by weight dispersion of Nafion in alcohols are then added to the suspension. This suspension is extensively sonicated by means of a tip sonicator; the resulting product is a suspension referred to as “SospAn”.

10.08 mg of SospCat are applied onto a Teflon sheet forming a 2×2 cm square. The solvent is then removed by drying at 90° C., thus forming a layer deposited on the Teflon layer. This layer is referred to as “EletCat”.

The EletCat layer is transferred by decal on one of the two faces of the Membr+StratIon that is covered by a StratIon layer. Specifically, the EletCat layer is made to position completely within the StratIon layer. This transfer is carried out by means of a hot-pressing procedure, bringing the system to 130° C. for 5 minutes and adopting a pressure of 5.52 MPa. The resulting product is referred to as “Membr+StratIon+EletCat”.

Membr+StratIon+EletCat is treated with a 0.5 M HNO₃ aqueous solution for 1 hour at ambient temperature. This treatment is repeated 3 times. Subsequently, Membr+StratIon+EletCat is washed for 20 minutes with bidistilled water at ambient temperature. This treatment is repeated 2 times. Membr+StratIon+EletCat is then dried by a dry air flow for 24 hours.

A SospAn aliquot is applied on the microporous layer of a 2×2 cm sized Teflon-coated carbon paper electrode so that the total platinum loading on the electrode is equal to 0.4 milligrams of platinum per square centimeter of electrode. For this to happen, the weight of the solid deposited on the electrode, obtained by drying the SospAn suspension, should be equal to 11.84 mg. The resulting electrode is referred to as “Pt/C ref. 2 anode”.

The Pt/C ref. 2 anode is placed in direct contact with the face of Membr+StratIon+EletCat on which the EletCat has not been transferred to. A 2×2 cm sized square of Teflon-coated carbon paper with a microporous layer is instead applied on the other face of Membr+StratIon+EletCat, that is the one where both the StratIon and the EletCat layers have been transferred to. Specifically, this microporous layer is placed in contact with the EletCat layer. The resulting system, consisting of the Pt/C ref. 2 anode electrode, the Membr+StratIon+EletCat, and the 2×2 cm sized square of Teflon-coated carbon paper with a microporous layer is subjected to a hot-pressing process that is carried out at a temperature of 146° C. and 2.76 MPa; these parameters are maintained for 5 min. At the end of this step, the MEA referred to as MEA5 is obtained.

A second MEA, referred to as MEA6, is prepared. MEA6 is absolutely identical to MEA5, with the only difference that in MEA 6 the ZnO nanoparticles having a diameter equal to 50 nm are not ground together with PtNi3, but simply added to SospCat together with the mixture obtained by intensively grinding 20 mg of PtNi3 with 10 mg of Vulcan XC-72R carbon black.

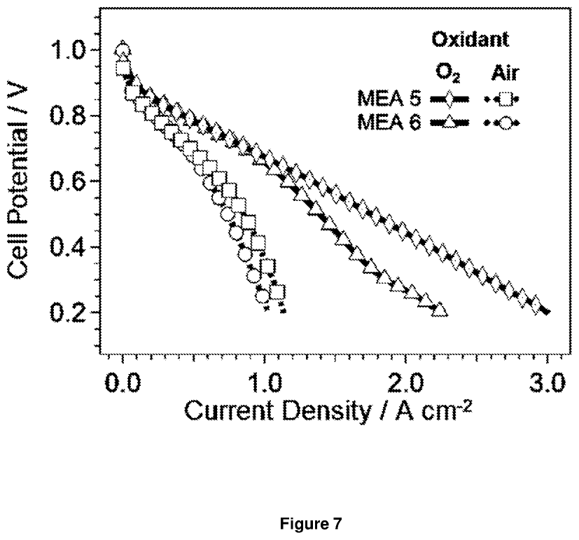

MEA5 and MEA6 are then tested in single cell. The corresponding polarized curves are shown in FIG. 7.

FIG. 7 shows how the current density generated by MEA 5 is higher than that generated by MEA 6, especially at low cell potential values. This result is interpreted as follows. Although both MEA 5 and MEA 6 comprise an EletCat layer obtained starting from a SospCat characterized by the same amounts of PtNi3, Vulcan XC-72R carbon black, ZnO nanoparticles with a diameter equal to 50 nm and Nafion, in MEA 5 the ZnO nanoparticles were intensively ground with EC PtNi3, while in MEA 6 the same nanoparticles were added to SospCat without grinding. Consequently, MEA 5 comprises a much more compact and homogeneous EletCat compared to MEA 6, probably because the grinding process has reduced the size of PtNi3. In this way, following acid treatment and consequent removal of the ZnO nanoparticles with a diameter of 50 nm, the accessibility of the active sites present in the EletCat of MEA 5 is improved compared to that of the active sites present in the EletCat of MEA 6. In conclusion, the active sites in MEA 5 can be more easily reached by the reagents and are able to better expel the products compared to MEA 6, thus inhibiting the flooding phenomena.

The performances of MEA 5, wherein ZnO acts as both a grinding agent and a pore-forming agent, are much better than those of MEA 6, wherein ZnO only acts as a pore-forming agent since it was only added to the ink after the electrocatalyst grinding. On the basis of these results, it is inferred that the introduction of ZnO both as a grinding agent and a pore-forming agent has a clearly improving effect on the MEA performances since: (i) the cavities formed significantly improve the distribution of the reactants within the electrocatalytic layer and (ii) the size of the electrocatalyst grains have been reduced, thus increasing its surface area and the accessibility of its active sites.

1. A membrane-electrode assembly (MEA) comprising:
an anode and a cathode facing each other;
an ion-exchange membrane placed between the anode and the cathode;
an electrocatalytic coating layer applied on both sides of said ion-exchange membrane;
an ion-exchange polymer layer placed between said membrane and at least one of the electrocatalytic layers;
characterized in that said electrocatalytic layer comprises micropores having an average diameter comprised between 0.001 and 50 micrometers, preferably between 0.01 and 1 micrometers and/or said electrocatalytic layer contains electrocatalyst particles having an average diameter comprised between 0.01 and 10 micrometers, preferably between 0.03 and 0.3 micrometers.

2. Membrane-electrode assembly according to claim 1, characterized in that said ion-exchange polymer is selected from the group comprising an ionomer apt to exchange: (i) cations; (ii) anions; or (iii) both anions and cations.

3. Membrane-electrode assembly according to claim 1 or 2, characterized in that said ion-exchange polymer layer has a thickness comprised between 2 and 1,000 micrometers, preferably between 2 and 50 micrometers.

4. Membrane-electrode assembly according to any one of the preceding claims, characterized in that said electrocatalytic layer comprises an electrocatalyst, preferably a carbonitride-based electrocatalyst having a “core-shell” morphology or an electrocatalyst comprising graphene oxide, graphene nitride, graphene, or graphene functionalized with —COON and/or —OH groups.

5. A method of producing the membrane-electrode assembly according to any one of claims 1 to 4, comprising the steps of:
(a) providing a dispersion of an ion-exchange polymer in a protic polar solvent or in a solution comprising more than one protic polar solvent;
b) applying said dispersion on an ion-exchange membrane or on at least one electrocatalytic layer applied on said membrane by means of (i) direct application on said membrane or on said at least one electrocatalytic layer, or (ii) application on an inert substrate followed by transfer on said membrane or on said at least one electrocatalytic layer, to form a membrane-polymeric layer system or an electrocatalytic layer-polymeric layer system;
c) removing the solvent, preferably by evaporation, vacuum evaporation, or drying;
d) optionally, subjecting said membrane-polymeric layer system or said electrocatalytic layer-polymeric layer system to pressing and/or treatment with at least one acid or basic aqueous solution;
characterized in that it further comprises the step of introducing at least one pore-forming agent into the electrocatalytic layer and the subsequent step of removing said at least one pore-forming agent from the electrocatalytic layer.

6. Method according to claim 5, characterized in that said pore-forming agent consists of particles having an average diameter comprised between 10,000 and 2 nm, preferably comprised between 200 and 20 nm.

7. Method of producing the membrane-electrode assembly according to any one of claims 1 to 4, comprising the steps of:
(a) providing a dispersion of an ion-exchange polymer in a protic polar solvent or in a solution comprising more than one protic polar solvent;
b) applying said dispersion on an ion-exchange membrane or on at least one electrocatalytic layer applied on said membrane by means of (i) direct application on said membrane or on said at least one electrocatalytic layer, or (ii) application on an inert substrate followed by transfer on said membrane or on said at least one electrocatalytic layer, to form a membrane-polymeric layer system or an electrocatalytic layer-polymeric layer system;
c) removing the solvent, preferably by evaporation, vacuum evaporation, or drying;
d) optionally, subjecting said membrane-polymeric layer system or said electrocatalytic layer-polymeric layer system to pressing and/or treatment with at least one acid or basic aqueous solution;
characterized in that said electrocatalytic layer contains electrocatalyst particles having an average diameter comprised between 0.01 and 10 micrometers, preferably between 0.03 and 0.3 micrometers, said particles being obtained by means of a grinding step of an initial electrocatalyst in the presence of at least one grinding agent and a subsequent step of removing said at least one grinding agent from said particles.

8. Method according to any one of claims 5 to 7, characterized in that said pore-forming agent or said grinding agent is selected from halides of alkali or alkaline-earth metals (LiBr, NaI, and CaCl₂), metal oxides (ZnO, TiO₂, SiO₂), inorganic salts of alkaline or alkaline-earth metals such as carbonates, sulfates, nitrates, phosphates, or a mixture thereof.

9. Method according to claim 7 or 8, characterized in that said grinding agent consists of particles having an average diameter comprised between 1 mm and 2 nm, preferably comprised between 100 and 10 nm.

10. Method according to any one of claims 7 to 9, characterized in that said grinding step ranges from 20 minutes to 400 hours, preferably ranges from 30 minutes to 1 hour, more preferably said grinding step is carried out at a temperature comprised between −270° C. and 1,700° C., preferably between −195° C. and 200° C., more preferably at ambient temperature.

11. Method according to any one of claims 7 to 10, characterized in that said grinding step is carried out in the presence of a liquid, preferably selected from water, alcohols, aldehydes, ketones, ethers, esters, hydrocarbons, amines, amides, or mixtures thereof.

12. Method according to any one of claims 5 to 11, characterized in that said electrocatalytic layer comprises an electrocatalyst material, and the ratio between the volume of the pore-forming agent or the grinding agent introduced into the electrocatalytic layer and the volume of said electrocatalyst material contained in the electrocatalytic layer ranges from 10 to 0.01, preferably ranges from 1 to 0.1.

13. Method according to any one of the claims 5 to 12, characterized in that said removing step is obtained by means of i) washing with an acid or basic aqueous solution, optionally in the presence of at least one gas bubbled through the aqueous solution; (ii) vacuum sublimation; (iii) ultrasound treatment; (iv) decantation; (v) filtration; (vi) addition of appropriate additives followed by flotation; (vii) treatment with an non-polar organic solvent, such as toluene, hexane, heptane, benzene, or a mixture thereof; (viii) treatment with an aprotic polar solvent, such as dimethylformamide, dimethylacetamide, N-methylpyrrolidone, tetrahydrofuran, or a mixture thereof; (ix) treatment with aldehydes, ketones, carboxylic acids, amines, or a mixture thereof.

14. A membrane-electrode assembly obtainable by the method according to any one of claims 5 to 13.

15. A fuel cell comprising the membrane-electrode assembly according to claims 1 to 4 or according to claim 14.
